(19) United States
(12) Patent Application Publication
(10) Pub. No.: US 2006/0050324 A1
(43) Pub. Date: Mar. 9, 2006

(54) Facsimile apparatus and facsimile transmission method

(75) Inventor: Shinichi Mitaku, Tochigi (JP)

Correspondence Address: GREENBLUM & BERNSTEIN, P.L.C., 1950 ROLAND CLARKE PLACE, RESTON, VA, 20191, US

(73) Assignee: Matsushita Electric Industrial, Co., Ltd., Osaka (JP)

(21) Appl. No.: 11/073,593

(22) Filed: Mar. 8, 2005

(30) Foreign Application Priority Data
Sep. 7, 2004 (JP) 2004-259896

(51) Int. Cl. H04N 1/00

(52) U.S. Cl. 358/400

(57) ABSTRACT

A configuration is provided that has a binding position designation unit that designates the binding position of a document, a reading unit that reads images on the front side and back side of the document and creates image data of each one, a judgment unit that judges whether the scanning start position of the document is the short side or the long side based on the scan length of a secondary scanning direction when the reading unit reads the document, and a control unit that controls the processing of image data in a manner such that the directions of the front side and back side of the document are correct based on information of the designated binding position of the document and the judged scanning start position of the document.

### BACKGROUND OF THE INVENTION

1. Field of the Invention

The present invention relates to a facsimile apparatus that can read and transmit both the front side and back side of a double-sided document, and in particular, relates to a facsimile apparatus that rearranges and transmits image data in such a manner that corrects the orientations of the front side and back side of the document that has been read. The present invention also relates to a related facsimile transmission method.

2. Description of Related Art

Conventionally, when transmitting a double-sided document using a facsimile apparatus, the direction of the image data of the front side and back side of the document would be transmitted incorrectly because the binding position of the document is provided either at the short side or at the long side, or because of differences in the manner the document is set in vertical or horizontal directions with respect to the document tray. Therefore, information related to a double-sided document was entered by the user or such information was detected by sensors, when transmitting the double-sided document.

For example, a paper width sensor was provided to detect the paper width of a document set in a document tray, and a paper length sensor was provided to detect the paper length of the document. It was determined, after comparing the paper width detected by the paper width sensor and the paper length detected by the paper length sensor, that the document has been set in the horizontal direction if the paper width is larger, and in the vertical direction if the paper length is larger. This technology also designates a binding position of the document and rotates the image of one side of the document surface to make the direction of the document correct, when the directions of the image data of the front side and back side of the document are incorrect.

[Related Art 1] Japanese Laid-Open Patent Publication No. 2003-134305

However, in this type of conventional technology, sensors must be provided to detect the paper width and the paper length in order to confirm the orientation of the document set in the document tray. Because it was necessary to provide the sensors, there were problems of the configuration of the apparatus becoming complex and the cost of the apparatus increasing.

### SUMMARY OF THE INVENTION

The present invention is a facsimile apparatus that eliminates the problem points of this type of conventional technology. The present invention has an objective of providing a facsimile apparatus that can judge the direction of a document set in a document tray using a simple and low-cost configuration, and then can process and transmit the image data such that the directions of the front side and back side of the document are correct without the need to provide special sensors to confirm the orientation of the document set in the document tray in a facsimile apparatus that can transmit a double-sided document.

In order to solve these types of problems, the facsimile apparatus according to the present invention is a facsimile apparatus that scans image data on both sides of a document, the document having a binding position, a plurality of the documents being bindable at the binding positions. The facsimile apparatus comprises a panel that inputs information regarding the binding position, the information indicating whether the binding position is provided at a long edge of the document or at a short edge of the document. The facsimile apparatus comprises a controller that determines whether a scanning start line of the document is set on the long edge of the document or on the short edge of the document, based on a scanning length of a secondary scanning direction of the scanned document. When the information regarding the binding position input by the panel indicates that the binding position is provided at the long edge of the document and when the scanning start line is determined to be set on the short edge of the document, the controller rotates the image data of the back side of the document by 180 degrees. Then, a transmitter transmits the image data of the front side of the document and the rotated image data of the back side of the document.

### BRIEF DESCRIPTION OF THE DRAWINGS

The present invention is further described in the detailed description which follows, with reference to the noted plurality of drawings by way of non-limiting examples of exemplary embodiments of the present invention, in which like reference numerals represent similar parts throughout the several views of the drawings, and wherein:

FIG. 1 illustrates a functional block diagram of the facsimile apparatus related to the embodiment of the present invention;

FIG. 2 illustrates a model view showing an outline of the read operation for a double-sided document by applying the facsimile apparatus shown in FIG. 1;

FIG. 3 (a) shows a first example of the configuration of a double-sided document transmitted by the facsimile apparatus shown in FIG. 1;

FIG. 3 (b) shows a second example of the configuration of a double-sided document transmitted by the facsimile apparatus shown in FIG. 1;

FIG. 3 (c) shows a third example of the configuration of a double-sided document transmitted by the facsimile apparatus shown in FIG. 1;

FIG. 3 (d) shows a fourth example of the configuration of a double-sided document transmitted by the facsimile apparatus shown in FIG. 1;

FIG. 4 (a) illustrates a first model view showing the relationship between the orientation of a double-sided document and the processing of the image data after being read in the facsimile apparatus shown in FIG. 1;

FIG. 4 (b) illustrates a second model view showing the relationship between the orientation of a double-sided document and the processing of the image data;

FIG. 4 (c) illustrates a third model view showing the relationship between the orientation of a double-sided document and the processing of the image data;

FIG. 4 (d) illustrates a fourth model view showing the relationship between the orientation of a double-sided document and the processing of the image data;

FIG. 5 illustrates a conceptual view showing a method to set a reference value utilized for judging the orientation of a document in the facsimile apparatus shown in FIG. 1;

FIG. 6 illustrates a flowchart showing the transmission operation of a double-sided document in the facsimile apparatus shown in FIG. 1;

FIG. 7 shows the arrangement of the display/control panel of the facsimile apparatus shown in FIG. 1; and

FIG. 8 shows examples of display screens in the display/control panel of FIG. 7.

### DETAILED DESCRIPTION OF PREFERRED EMBODIMENTS

The embodiments of the present invention are explained in the following, in reference to the above-described drawings.

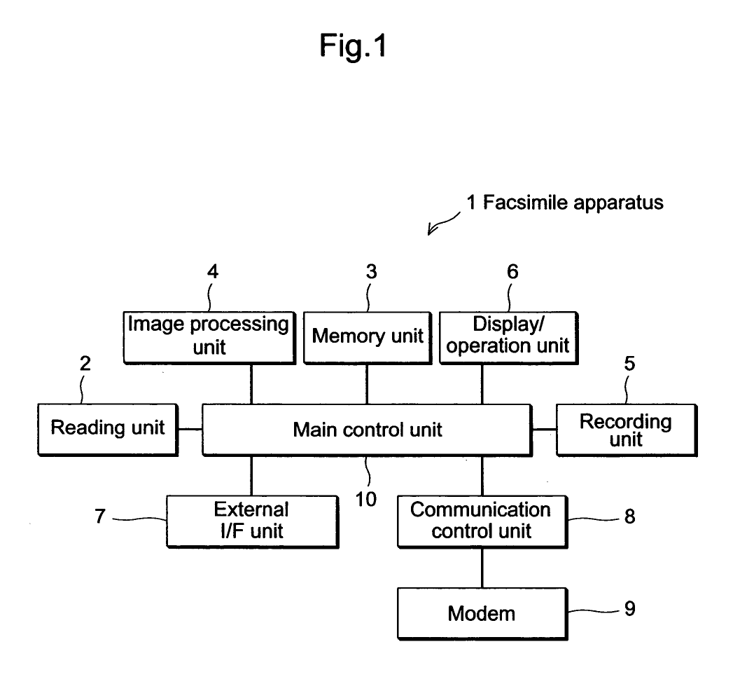

FIG. 1 illustrates a functional block diagram showing an outline of the configuration of the facsimile apparatus related to the embodiment of the present invention. This facsimile apparatus 1 can read a double-sided document of a specified size, can process the image data in a manner such that the directions of the front side and back side of the document are correct, and then can transmit the processed image data. The facsimile apparatus 1 mainly includes a reading unit 2, a memory unit 3, an image processing unit 4, a recording unit 5, a display/operation unit 6, an external interface (I/F) unit 7, a communication control unit 8, a modem 9, and a main control unit 10.

The reading unit 2 reads images of a document fed from a document tray by a feed mechanism and then creates image data. In particular, the reading unit 2 transfers, to the memory unit 3, data having the number of lines of a secondary scan when a double-sided document is read, and stores the data in the memory unit 3. The memory unit 3 stores each type of data that includes image data created by the reading unit 2 and image data received by another facsimile apparatus. The image processing unit 4 performs various processes on image data created by the reading unit 2. In particular, the image processing unit 4 performs processes to make the direction of the front side and back side of the document match by rotating the other side of the image, when the directions of the front side and back side of the document do not match and when a double-sided document is read. The recording unit 5 records image data created by the reading unit 2 and image data received from another facsimile apparatus onto recording paper. The display/operation unit 6 has a display screen that displays the state of the apparatus as well as the setting information to the user and has control buttons where the user enters each type of setting. In particular, the display/operation unit 6 functions as a unit to allow the user to designate whether the binding position of the document is the short side or the long side when transmitting double-sided document. The external interface (I/F) unit 7 connects to external devices and can transmit and receive various types of data (including image data) and programs. The communication control unit 8 controls the transmission and reception operations of the facsimile between other facsimile apparatuses. The modem 9 modulates image data for transmission that has been processed by the image processing unit 4 and then transmits the modulated data to other facsimile apparatuses through a specified communication line.

The main control unit 10 systematically controls each of the above-mentioned units. In particular, the main control unit 10 functions as a unit to compare, with a previously set reference value, a length conversion value of the number of lines in the secondary scanning direction (scanning length in the secondary scanning direction) obtained when the reading unit 2 reads a document. After the comparison, it is determined that the orientation of the document in the reading unit 2 is vertical placement when the length conversion value of the number of lines in the secondary scanning direction is larger than the reference value (scanning start position of the document is the short side), or that the orientation of the document in the reading unit 2 is horizontal placement when the length conversion value of the number of lines is smaller than the reference value (scanning start position of the document is the long side). Furthermore, the main control unit 10 performs a rotation process of image data in the image processing unit 4 to make the directions of the front side and back side of the document match, based on the binding position of the document designated by the user using the display/operation unit 6 and based on the judged orientation of the document.

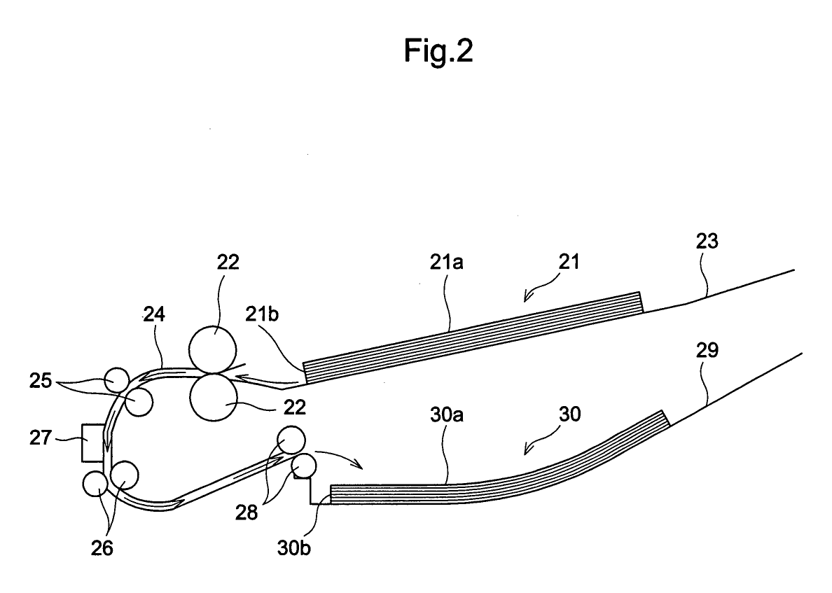

FIG. 2 illustrates a model view showing an outline of the read operation for a double-sided document by applying the facsimile apparatus shown in FIG. 1. In this figure, it is shown that the facsimile apparatus reads the back side of a double-sided document in order from last page after reading the front side of the double-sided document in order from the first page. The document includes a plurality of sheets.

In order to read the image on the front side of a double-sided document when transmitting a facsimile of a double-sided document, the user initially sets the document 21 in the document tray 23 with the front side 21a facing upward and the front edge 21b facing the pick-up roller 22. Then, sheets of the document 21 on the document tray 23 are sent to the inside of the feed path 24 one-at-a-time by the pick-up roller 22 and then fed by each of the feed rollers 25, 26 when the read of the front side of the document 21 starts. The front side of the document is scanned and the image is read when the document 21 pass through the image sensor 27. Sheets of the document that have been read are delivered by the delivery roller 28. At this time, the delivered document 30 is loaded onto the delivery tray 29 with the back side 30a facing upward and the back edge 30b facing the delivery roller 28.

When the read of the front side of the document is finished, the user extracts the document 30 arranged on the delivery tray 29 and sets it onto the document tray 23 in order to read the images on the back side of a double-sided document. In other words, the extracted document 30 is set onto the document tray 23 with the back side 30a facing upward and the back edge 30b facing the pick-up roller 22. Thereafter, the images on the back side are read in the same manner as the front side.

For convenience sake, in the following, a read operation of a double-sided document performed in the above-mentioned manner is assumed in this embodiment. However, the present invention is not limited to this above-mentioned read operation. As an example, the present invention can also be applied to a configuration in which a document is loaded onto a document tray such that the front side of the document faces the delivery roller when an image of the back side is read. In addition, the present invention can also be applied to a configuration in which a reversal mechanism is provided inside the feed path of the document and in which images on the front side and back side of each individual document are read without the user setting the document again.

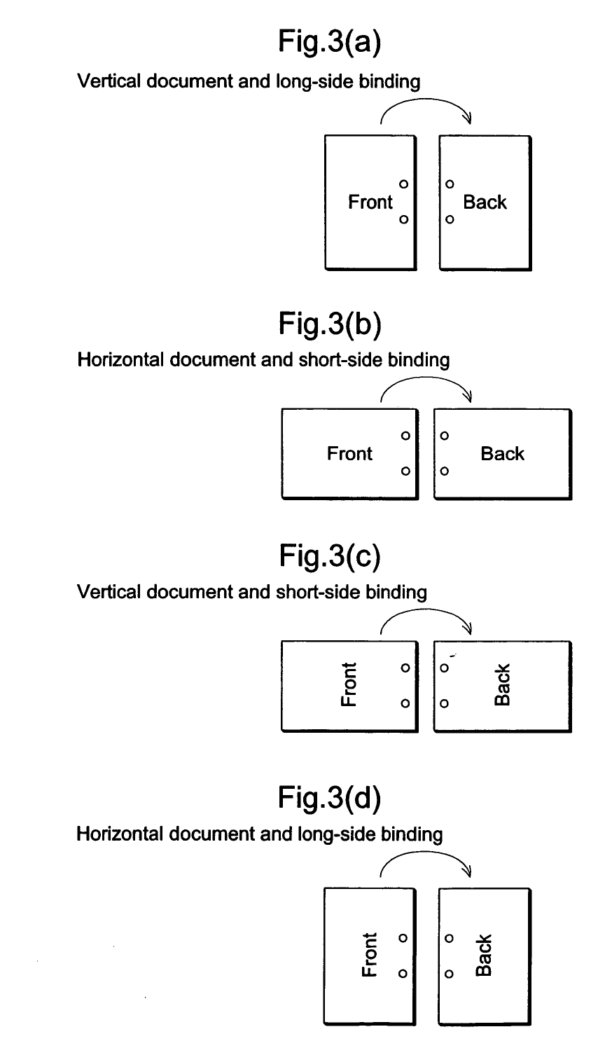

FIG. 3 shows example of the configuration of a double-sided document transmitted by the facsimile apparatus shown in FIG. 1. FIGS. 3(a) to 3(d) show the state of the front side and back side of one double-sided document. A double-sided document is organized such that the images on the front side and back side (such as characters and pictures) have the same orientation when rotated left/right or up/down with the binding position as the axis. The images on the front side and back side are also classified into (a) vertical document and long-side binding, (b) horizontal document and short-side binding, (c) vertical document and short-side binding, and (d) horizontal document and long-side binding.

Here, “vertical document” are defined as document with a correct image direction when oriented vertically while being read. On the other hand, “horizontal document” are defined as document with a correct image direction when oriented horizontally while being read. Characters of the “front” and the “back” shown on each document are shown on the respective front side and back side of each document, and the direction of characters of the “front” and the “back” match the direction of the document images. Moreover, the two circles shown at the short side and long side of the document show the binding positions of the document.

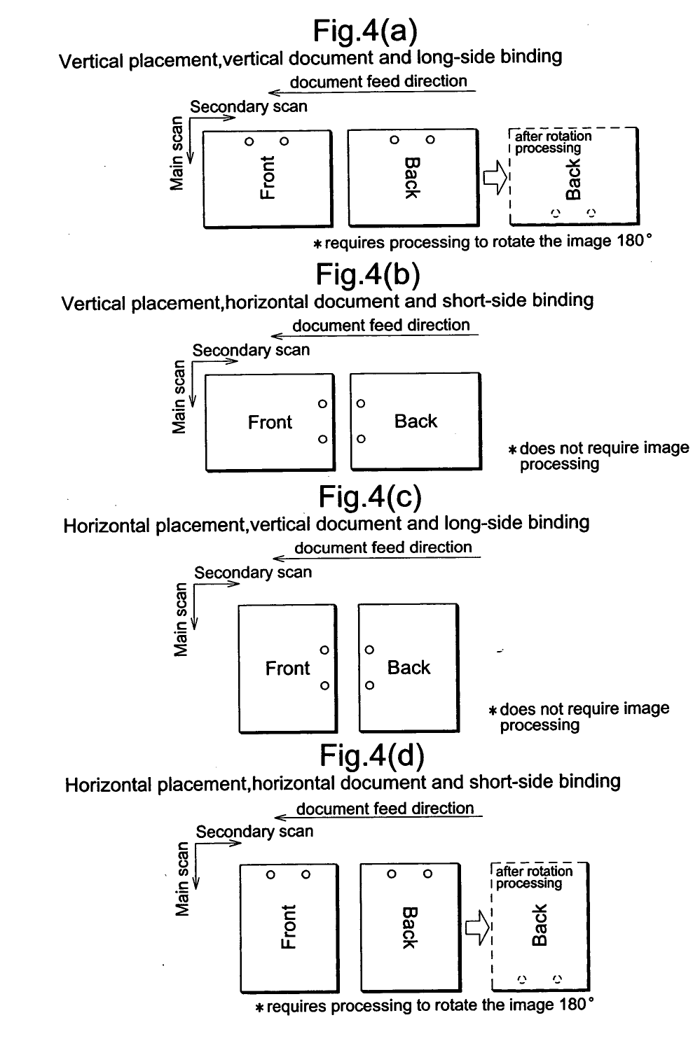

FIG. 4 illustrates a schematic view showing the relationship between the orientation of a double-sided document and the processing of the image data after being read in the reading unit of the facsimile apparatus shown in FIG. 1. This figure provides a description for the double-sided document shown in FIGS. 3(a) and 3(b) as typical examples. The double-sided document shown in FIGS. 3(c) and 3(d) can also be handled in the same manner as FIGS. 3(a) and 3(b).

The orientation of the double-sided document in the reading unit 2 is classified into (a) vertical placement, vertical document and long-side binding, (b) vertical placement, horizontal document and short-side binding, (c) horizontal placement, vertical document and long-side binding, and (d) horizontal placement, horizontal document and short-side binding. It is shown that, as described in FIG. 2, the document is sent in the document feed direction shown by the arrow, the images on the front side are read, the front and back sides of the document are reversed, the document is sent in the document feed direction once again, and the images of the back side are read.

Here, “vertical placement” is defined as the orientation of document with a scanning start position of the document on the short side. On the other hand, “horizontal placement” is defined as the orientation of document with a scanning start position of the document on the long side. In addition, the direction that perpendicularly intersects the document feed direction is the main scanning direction. On the other hand, the direction that matches the document feed direction is the secondary scanning direction. The characters of the “front” and the “back” shown on each document and the binding position of the document are the same as FIG. 3.

In FIGS. 4(a) and 4(d), the images on the front side and back side that has been read are opposite the document direction while the images in FIGS. 4(b) and 4(c) match the document direction. Because of this, (a) and (d) require processing that rotates the image data of the back side by 180° in order to obtain a correct document direction. In contrast, (b) and (c) do not require processing that rotates the image data.

Here, the processing of the image data of one-sheet double-sided document is shown. However, when a document having a plurality of sheets is read, a sorting process can be executed. The sorting process performs processing to store, in memory, the image data of the front side and the back side that has been read, and to rotate the image data of the back side by 180° as described above while arranging the image data into the correct order, e.g., front side 1^{st} page, back side 1^{st} page, front side 2^{nd} page, back side 2^{nd} page and so on.

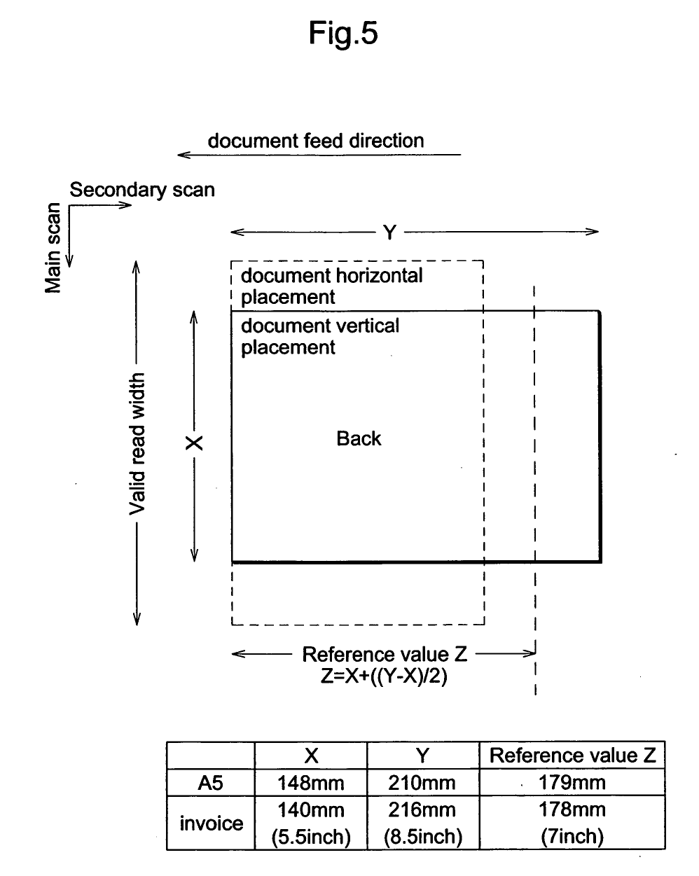

FIG. 5 illustrates a conceptual view showing a method for setting a reference value. The reference value is utilized for judging the orientation of a document in the reading unit of the facsimile apparatus shown in FIG. 1. In this embodiment, the valid read width (maximum document size that can be read) of the reading unit 2 is equivalent to A4 size (210 mm×297 mm) or letter size (approx. 216 mm (8.5 inch)×approx. 279 mm (11 inch)), and the regulated size of a double-sided document is A5 size (148 mm×210 mm) or invoice size (approx. 140 mm (5.5 inch)×approx. 216 mm (8.5 inch)) which are respectively half the size of the A4 and letter size.

The length conversion value of the number of lines in the secondary scanning direction obtained when the reading unit 2 reads a document corresponds to both length X of the short side of the document or length Y of the long side of the document, depending on whether the document is vertical placement or horizontal placement respectively. Because of this, the reference value Z used to compare these X with Y values and to judge the orientation of the document can be set as a value smaller than length Y of the long side but larger than length X of the short side of the document (X<Z<Y). The preferred example here shows that the reference value is set to a value between X and Y (reference value=X+((Y−X)/2)). If reference values are calculated for A5 size or invoice size as values between length X of the short side and length Y of the long side, the reference value will be 179 mm for an A5 size or the reference value will be approx. 178 mm for an invoice size.

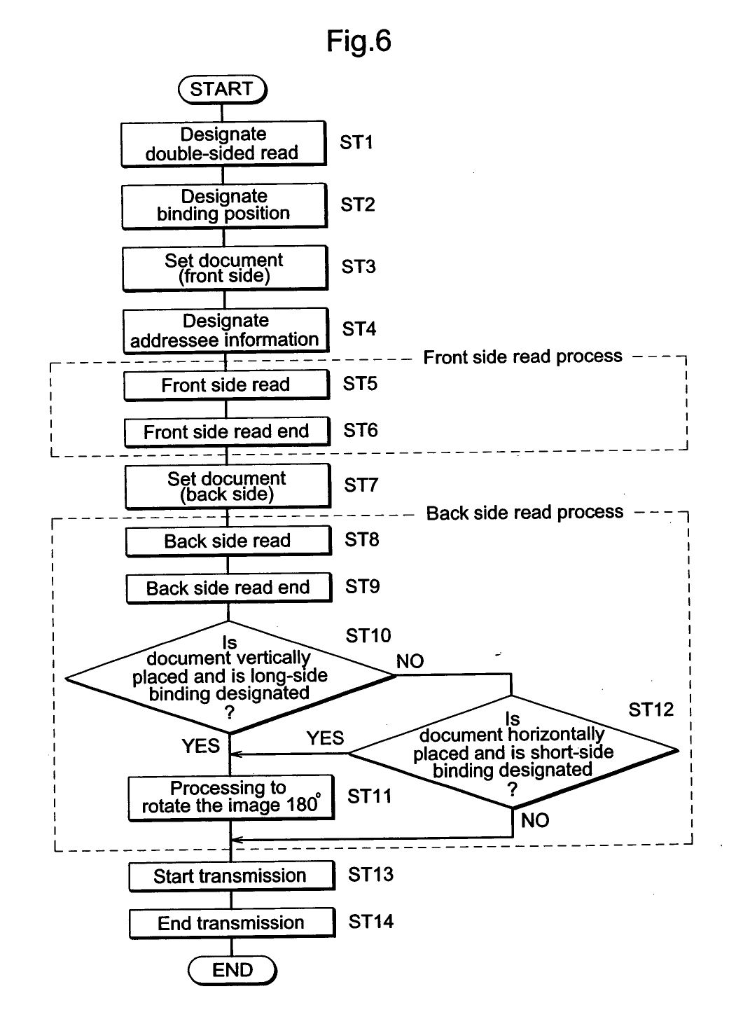

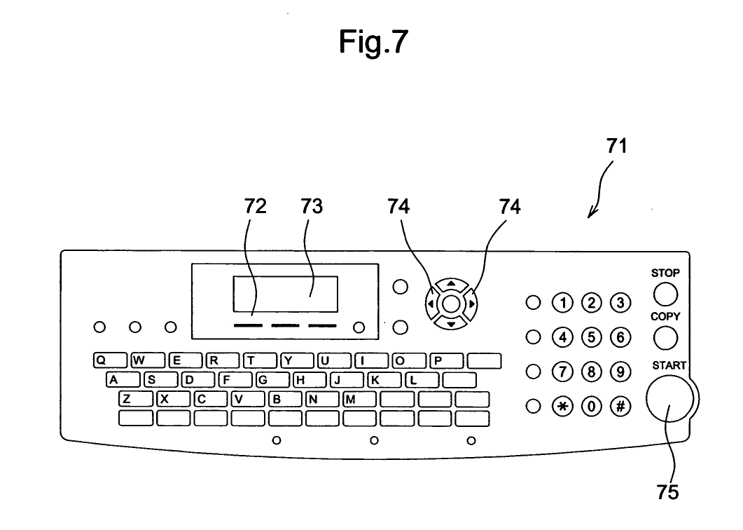

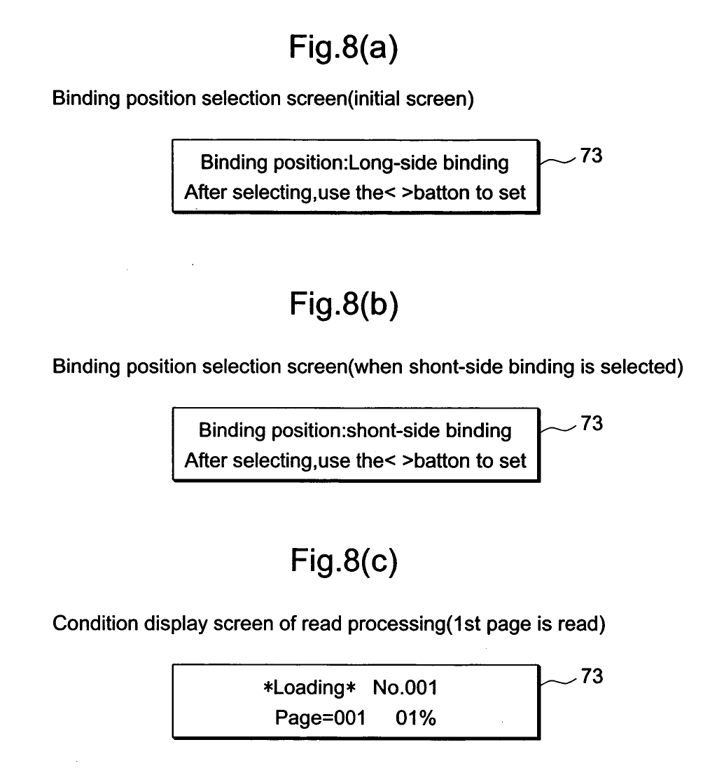

FIG. 6 illustrates a flowchart showing the transmission operation of a double-sided document in the facsimile apparatus shown in FIG. 1. The setting input operations performed by a user will be described here while referring to the display/operation panel shown in FIG. 7, and the setting input information will be displayed in the display screen of the display/control panel shown in FIG. 8.

At first, when a user presses the double-sided transmission mode (DUPLEX) button 72 of the display/control panel 71 and when the double-sided transmission mode is designated by the user (ST1), setting input information for designating the binding position of the document is displayed in the display screen 73 as shown in FIG. 8 (a). Although long-side binding is designated as the initial setting here, it is possible to change from long-side binding to short-side binding by operating the arrow buttons 74 of the display/control panel 71 as shown in FIG. 8 (b). After designating the binding position of the document (ST2), the user sets the document onto the document tray in order to read the images on the front side of the document (ST3). At this time, a message for the user can also be displayed in the display screen 73 indicating the necessity to set the document onto the document tray with the front side of the document facing upward. In addition, the user designates information concerning where to send the facsimile, by using the display/control panel 71 (ST4).

At this point, when the user presses the transmission start button (START) 75, the read processing of the images on the front side of the document is started and the only the images on the front side of the document are sequentially read (ST5). Here, the progress of the read processing is displayed in the display screen 73 as shown in FIG. 8 (c). The number of lines of a secondary scan, obtained when the reading unit 2 reads each document, is stored in the memory unit 3 at this time. When all the images have been completely read and the document is loaded onto the delivery tray (ST6), the user extracts the document loaded on the delivery tray and then sets it onto the document tray as is with back side of the document facing upward (ST7). At this time, a message for the user can also be displayed in the display screen 73 indicating that the document should be set onto the document tray without changing the direction of the document.

Thereupon, when the user presses the transmission start button 75, the read processing of the images on the back side of the document is started and the only the images on the back side of the document are sequentially read (ST8). When all the images have been completely read (ST9), the main control unit 10 judges whether the orientation of the document is vertical placement and whether long-side binding has been designated (ST10). Here, as described in FIG. 5, the length conversion value of the number of lines in the secondary scanning direction stored in the memory unit 3 and the predetermined reference value are compared, before a judgment is made for the orientation of the document. When there are a plurality of sheets in the document, the maximum value (among the plurality of length conversion values of the number of lines in the secondary scanning direction stored in the memory unit 3) and the predetermined reference value are compared and for making the judgment.

In step ST10, when it is judged that the orientation of the document is vertical placement and that long-side binding has been designated, the main control unit 10 performs processing in the image processing unit 4 that rotates the image data of the back side by 180° to make the directions of the front side and back side of the document match (ST 11). In contrast, when it is judged that the orientation of the document is horizontal placement or that short-side binding has been designated in step ST10, it will be judged whether the orientation of the document is horizontal placement as well as the short-side binding has been designated (ST12).

In step ST12, when it is judged that the orientation of the document is horizontal placement and that the short-side binding has been designated, the main control unit 10 performs processing in the image processing unit 4 that rotates the image data of the back side by 180° to make the directions of the front side and back side of the document match.

Finally, when the process that rotates the image data of the back side 180° has been performed and when the directions of the front side and back side of the document become correct (ST 11), or when it is not necessary to perform the rotation process of the image data (ST12: NO), the facsimile transmission is started (ST13). If the transmission ends correctly there, the transmission operation of the double-sided document will end.

It is noted that the foregoing examples have been provided merely for the purpose of explanation and are in no way to be construed as limiting of the present invention. While the present invention has been described with reference to exemplary embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular structures, materials and embodiments, the present invention is not intended to be limited to the particulars disclosed herein; rather, the present invention extends to all functionally equivalent structures, methods and uses, such as are within the scope of the appended claims.

The present invention is not limited to the above described embodiments, and various variations and modifications may be possible without departing from the scope of the present invention.

This application is based on the Japanese Patent Application No. 2004-259896 filed on Sep. 7, 2004, entire content of which is expressly incorporated by reference herein.

What is claimed is:

1. A facsimile apparatus comprising:
a scanner configured to scan image data on both sides of a document, the document having a binding position, a plurality of the documents being bindable at the binding positions;
a panel configured to input information regarding the binding position, the information indicating whether the binding position is provided at a long side of the document or at a short side of the document;
a transmitter configured to transmit the scanned image data; and
a controller configured to determine whether a scanning start position of the document is set on the long side of the document or on the short side of the document, based on a scanning length of a secondary scanning direction of the scanned document,
the controller, when the information regarding the binding position input by the panel indicates that the binding position is provided at the long side of the document and when the scanning start position is determined to be set on the short side of the document, being further configured to rotate the image data of the back side of the document by 180 degrees,
the transmitter being further configured to transmit the image data of the front side of the document and the rotated image data of the back side of the document.

2. The facsimile apparatus according to claim 1, wherein the controller compares the scanning length of the secondary scanning direction of the scanned document with a predetermined value, and determines that the scanning start position of the document is set on the long side of the document when the scanning length of the secondary scanning direction of the scanned document is shorter than the predetermined value.

3. The facsimile apparatus according to claim 1, wherein the controller compares the scanning length of the secondary scanning direction of the scanned document with a predetermined value, and determines that the scanning start position of the document is set on the short side of the document when the scanning length of the secondary scanning direction of the scanned document is longer than the predetermined value.

4. The facsimile apparatus according to claim 2, wherein the predetermined value is set as a middle value between a length of the long side of the document and a length of the short side of the document.

5. The facsimile apparatus according to claim 1, wherein a maximum size of the scanned document is a half of a maximum size that the scanner can scan.

6. The facsimile apparatus according to claim 1, wherein, when the scanner scans a plurality of the documents and when the controller obtains a plurality of the scanning lengths of the secondary scanning directions of the scanned documents, the controller determines whether the scanning start positions of the documents are set on the long sides of the documents or on the short sides of the documents, based on the longest scanning length of the secondary scanning directions of the scanned documents.

7. A facsimile apparatus comprising:
a scanner configured to scan image data on both sides of a document, the document having a binding position, a plurality of the documents being bindable at the binding positions;
a panel configured to input information regarding the binding position, the information indicating whether the binding position is provided at a long side of the document or at a short side of the document;
a transmitter configured to transmit the scanned image data; and
a controller configured to determine whether a scanning start position of the document is set on the long side of the document or on the short side of the document, based on a scanning length of a secondary scanning direction of the scanned document,
the controller, when the information regarding the binding position input by the panel indicates that the binding position is provided at the short side of the document and when the scanning start position is determined to be set on the long side of the document, being further configured to rotate the image data of the back side of the document by 180 degrees,
the transmitter being configured to transmit the image data of the front side of the document and the rotated image data of the back side of the document.

8. A facsimile transmission method comprising:
scanning image data on both sides of a document, the document having a binding position, a plurality of the documents being bindable at the binding positions;
inputting information regarding the binding position, the information indicating whether the binding position is provided at a long side of the document or at a short side of the document;
determining whether a scanning start position of the document is set on the long side of the document or on the short side of the document, based on a scanning length of a secondary scanning direction of the scanned document;
rotating the image data of the back side of the document by 180 degrees, when the input information regarding the binding position indicates that the binding position is provided at the long side of the document and when the scanning start position is determined to be set on the short side of the document; and
transmitting the image data of the front side of the document and the rotated image data of the back side of the document.

9. A facsimile transmission method comprising:
scanning image data on both sides of a document, the document having a binding position, a plurality of the documents being bindable at the binding positions;
inputting information regarding the binding position, the information indicating whether the binding position is provided at a long side of the document or at a short side of the document;
determining whether a scanning start position of the document is set on the long side of the document or on the short side of the document, based on a scanning length of a secondary scanning direction of the scanned document;
rotating the image data of the back side of the document by 180 degrees, when the input information regarding the binding position indicates that the binding position is provided at the short side of the document and when the scanning start position is determined to be set on the long side of the document; and
transmitting the image data of the front side of the document and the rotated image data of the back side of the document.
